(19) United States
(12) Patent Application Publication
(10) Pub. No.: US 2003/0067397 A1
(43) Pub. Date: Apr. 10, 2003

(54) Object locating system employing RF signaling

(76) Inventor: Bradley G. Trimble, Milwaukee, WI (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/279,405

(22) Filed: Oct. 24, 2002

Related U.S. Application Data
(63) Continuation of application No. 09/679,841, filed on Oct. 5, 2000, now abandoned.
(60) Provisional application No. 60/157,955, filed on Oct. 6, 1999.
(60) Provisional application No. 60/225,208, filed on Aug. 14, 2000.

(51) Int. Cl. G08B 5/22

(52) U.S. Cl. 340/825.49

(57) ABSTRACT

An object locating system includes a control unit for activating a plurality of electronic tags to assist in locating keys, remote control devices, cordless phones, eyeglasses, articles of clothing, etc. to which the tags have been attached. The tags are self-contained, battery powered devices that signal their presence, when activated, by an audible and/or visual indication to get the attention of the user. In one embodiment for locating objects in a user's residence, a telephone interface unit responds to DTMF signals transmitted to a multi-frequency receiver over a communication link from a telephone at a location remote from or in the user's residence to produce an RF activating signal for activating a tag associated with an object to be located. The system can be used for identifying baggage, luggage, sporting equipment, and packages being dispensed from an airport baggage carousel.

### Related applications

This application is a continuation of application Ser. No. 09/679,841, which was filed on Oct. 5, 2000, which application claims benefit of provisional application serial No. 60/157,955 which was filed Oct. 6, 1999, and provisional application serial No. 60/225,208 which was filed Aug. 14, 2000.

### BACKGROUND OF THE INVENTION

This invention relates to a system and apparatus for locating or identifying objects, and more particularly, to a system and apparatus including selectively actuated radio frequency receivers carried by objects to be located and which are responsive to radio frequency signals transmitted by a transmitter for providing an audible and/or visual indication to aid a person in locating or identifying an object.

Various methods have been proposed for locating lost or misplaced items such as keys, eyeglasses, wallets or purses, remote control devices, and generally items which are hand-carried by a person and which are prone to misplacement. The items can be concealed by furniture and other objects or the items can be simply placed in an unusual location where the owner subsequently has difficulty in locating them. In known item location systems, signal receivers are coupled to the items, which are prone to misplacement, each signal receiver being responsive to a unique activation signal. A hand-held transmitter is used to control selective activation of the signal receivers to cause the signal receiver associated with a lost or misplaced item to provide an audible response to indicate the location of the item.

Typically, known item location systems have been used for locating lost or misplaced items within a personal residence, such as a house or an apartment. In such systems, a radio frequency link is established between a RF transmitter carried by a person seeking an item and a RF receiver attached to the item being sought. Generally, such a system is used by one person to locate only about four to six items. No provision is made for simultaneously locating a plurality of objects for several people.

A further consideration is that elderly or infirmed persons may have difficulty in using the transmitter to find an item, such as eyeglasses or keys. Consequently, such person may have to seek the assistance of another person, such as a neighbor, a relative or a friend. Typically, the person seeking the item would either have to leave their residence seeking help from a neighbor, a relative or a friend, for example, or would have to telephone the neighbor, the relative or the friend to seek help and direction in locating the lost or misplaced item. Frequently, this might require that the person whose assistance was requested would have to physically go to the residence of the person seeking the eyeglasses or keys to help find the lost items.

A further consideration is that the remote receivers that are used in a known item location systems are identical in appearance and, as such, do not uniquely identify an item with which it is associated. Although such receiver, when activated, produces an audible signal, such signal is not always helpful in identifying an item in crowded or noisy locations.

### SUMMARY OF THE INVENTION

The present invention provides a system and apparatus for locating and/or identifying objects. In one embodiment, the object locating system provided by the present invention includes at least one control unit which is used to activate a plurality of receivers, such as electronic tags. The electronic tags are remotely activated devices used to assist in locating an object to which the tags have been attached. The objects to be located can be inanimate objects, such as a set of keys, a remote control device, a cordless phone, a pair of glasses, an article of clothing, a wallet/purse, a hand tool, and generally any item which can be hand-carried by a person and is prone to misplacement. Moreover, the objects to be located can be animate objects, such as a pet or other animal. In one embodiment, the electronic tags are self-contained, battery powered devices that signal their presence when activated. When activated, the electronic tags produce an audible and/or visual indication for getting the attention of the user. In one embodiment, a telephone interface unit responds to frequency signals transmitted over a communication link for producing RF activating signals for activating an electronic tag associated with an object to be located.

Further in accordance with the invention, another embodiment provides system and apparatus for identifying baggage, such as luggage, sporting equipment, packages, and the like, which have been checked during travel and which are being distributed or dispensed by airline personnel, and in particular, from a carousel in an airport, for example.

### BRIEF DESCRIPTION OF THE DRAWINGS

The features of the present invention which are believed to be novel are set forth below. The invention, together with the further objects and advantages thereof, may best be understood by reference to the following description taken in conjunction with the accompanying drawings, wherein like reference numerals identify like elements, and wherein:

FIG. 1 is a simplified representation of an object locating system including a control unit and a plurality of electronic tags provided by the invention;

FIG. 1A is a simplified representation of an object locating system provided by the invention and in which the electronic tags can be activated from a remote location;

FIG. 1B is a simplified representation of an object locating system provided by the invention and including a master control unit;

FIG. 2 is a perspective view of a control unit of the object locating system provided by the invention;

FIG. 3 is a plan view of the control unit of FIG. 2;

FIG. 4 is a fragmentary vertical section view taken along the line 4-4 of FIG. 3;

FIG. 5 is a fragmentary vertical section view taken along the line 5-5 of FIG. 3;

FIG. 6 is a plan view of a master control unit provided by the invention;

FIG. 7 is a plan view of another embodiment of the control unit shown in FIG. 1;

FIG. 8 is a plan view of an electronic tag of the object locating system of the invention;

FIG. 9 is a side view of an electronic tag of FIG. 8;

FIG. 10 is a block diagram of the control unit of FIG. 2;

FIG. 11 is a block diagram of the electronic tag of FIG. 8;

FIG. 12 is a timing chart illustrating the drive pulses for the alarm generating device in line A and illustrating the drive pulses for the indicator in line B;

FIG. 13 is a perspective view of a telephone interface and control unit provided by the invention;

FIG. 14 is a block diagram of the telephone interface and control unit of FIG. 13;

FIG. 15 is a process flow chart for the microprocessor of the telephone interface and control unit of FIGS. 13 and 14;

FIG. 16 is an isometric view of a luggage locator tag provided by the present invention and shown secured to a handle of a piece of luggage;

FIG. 17 is an isometric view of a control unit for activating the luggage locator tag of FIG. 16;

FIG. 18 illustrates a luggage locator tag built into a handle of a piece of luggage;

FIG. 19 is a perspective view of a piece of luggage which has a luggage locator tags built into each side of the luggage;

FIG. 20 is a side view of a piece of luggage which includes a further embodiment for a luggage locator tag built into the luggage;

FIG. 21 is an enlarged end view of the luggage locator tag of FIG. 16 and showing the lens;

FIG. 22 is an enlarged view of a luggage locator tag, which includes a case of a transparent material;

FIG. 23 is a plan view of a key fob for a vehicle for providing remote keyless entry, and which incorporates components of a locator tag in accordance with the present invention;

FIG. 24 is a plan view of the key fob of FIG. 23, partially cut away to show components of a locator tag located within the key fob;

FIG. 25 is a plan view of a master control unit for activating the locator components of the key fob of FIG. 23;

FIG. 26 is an isometric view of a portable tool incorporating a locator tag in accordance with the present invention; and

FIG. 27 is an isometric view of a pet collar incorporating a locator tag in accordance with the present invention.

### DETAILED DESCRIPTION OF THE PREFERRED EMBODIMENTS

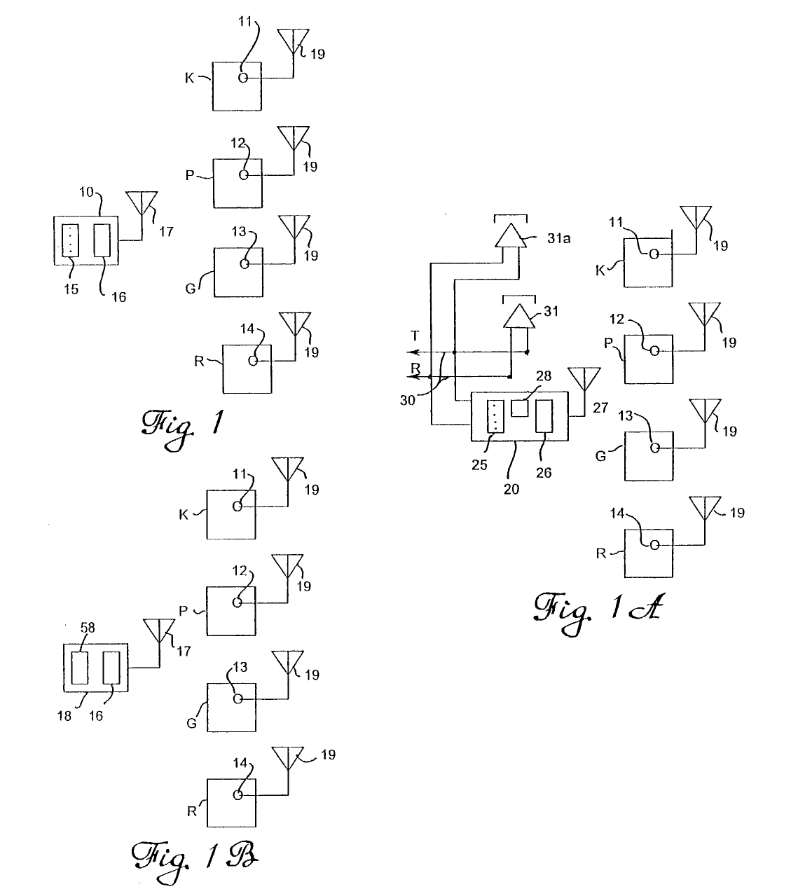

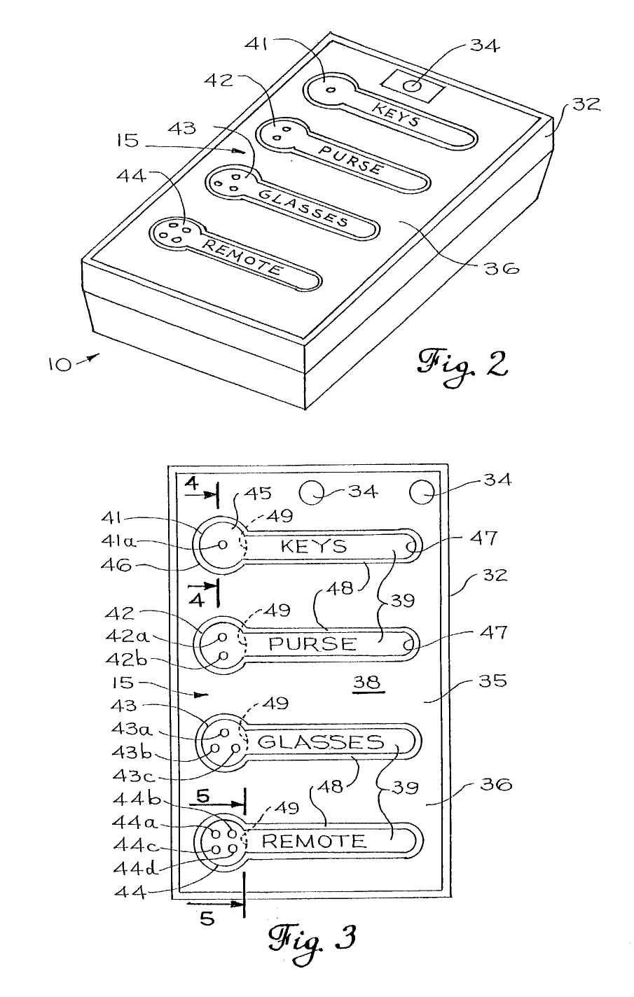

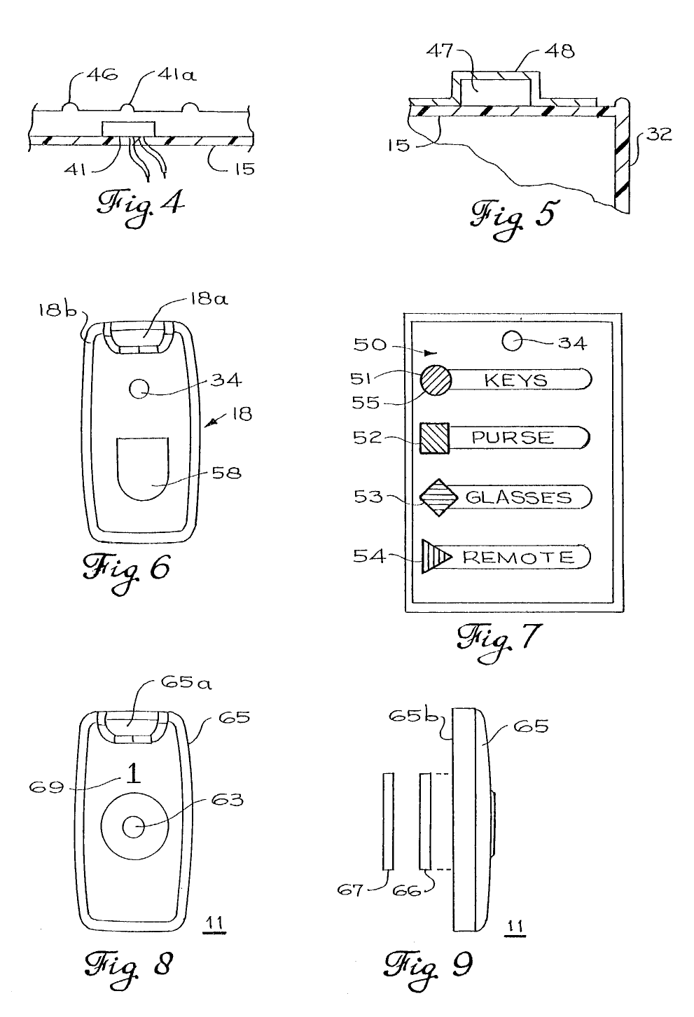

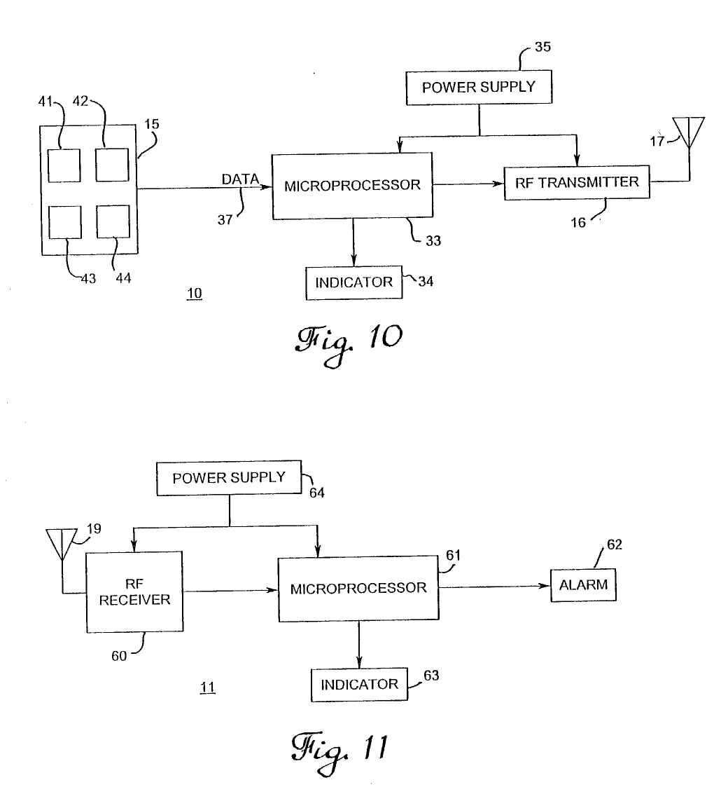

Referring to the FIG. 1 of the drawings, in one embodiment, the object locating system provided by the present invention includes at least one control unit 10 which is used to activate one or more electronic tags, such as electronic tags 11-14. The electronic tags 11-14 are remotely activated devices used to assist in locating an object to which the tags have been attached. The objects K, P, G and R to be located can be inanimate objects, such as a set of keys, a wallet/purse, a pair of eyeglasses, a remote control device, a cordless phone, an article of clothing, a portable tool, and generally any item which can be hand-carried by a person and is prone to misplacement. Moreover, the objects to be located can be animate objects, such as a pet or other animal. As described more fully below, such objects can include one or more packages, such as but not limited to items of luggage. The electronic tags 11-14 are self-contained, battery powered devices that signal their presence when activated. When activated, the electronic tags produce an audible and/or visual indication for getting the attention of the user. In one embodiment, the electronic tags 11-14 produce both an audible signal and a visual indication when activated.

The object locating system employs radio frequency (RF) signaling for locating lost or misplaced objects. The control unit 10 includes an RF signal transmitter 16 that transmits a plurality of coded RF signals each of which is detectable by a different one of the electronic tags 11-14. The coded RF signals are radiated by an antenna 17 of the control unit 10 and are picked up by an antennas 19 of the electronic tags 11-14. In one embodiment, the electronic tags are configured to work on a different one of four system carrier modulation codes. A fully configured system can include four unique electronic tags. The control unit includes a selecting apparatus 15 for selecting the one of the four carrier modulation codes to be transmitted to activate the electronic tag associated with an object to be located. While in one embodiment, the object locating system includes only four electronic tags 11-14, it is apparent that the object locating system can include more than four electronic tags with appropriate modification of the selecting apparatus 15 and the RF transmitter 16 of the control unit to enable the control unit 10 to produce additional coded RF signals.

Referring to FIG. 1A, the electronic tags 11-14 can be activated from a remote location using signals transmitted over a communication link. Preferably, at least a portion of the communication link includes a standard telephone link, but other portions of the communication link can include wireless telephones, cell phones, Internet connections and dedicated lines, for example.

In one embodiment, the communication link is a standard telephone line 30 and the object locating system can include a telephone interface and control unit 20. The telephone interface and control unit 20, hereinafter referred to as the telephone interface unit 20, is adapted to be coupled to the telephone line 30 at the location of the telephone 31, for example, in the user's residence. The telephone interface unit 20 includes a selecting apparatus 25 and an RF signal transmitter 26 which correspond to the selecting apparatus 15 and RF signal transmitter 16 of the control unit 10. In addition, the telephone interface unit 20 includes a frequency signal receiver 28 which responds to frequency signals transmitted over the telephone line 30 for causing the transmitter to transmit RF activating signals for activating the electronic tag associated with an object to be located. In one embodiment, the conventional dual tone, multi-frequency signals of the telephone system are used in causing remote activation of electronic tags.

Briefly, a person looking for an item, such as a pair of eyeglasses, can telephone a neighbor, a relative or a friend and tell that person that assistance is needed in locating the eyeglasses. This neighbor, relative or friend, who has been previously been made aware of how to respond to such call for assistance, would depress preselected pushbuttons on their telephone. This causes a sequence of known, conventional, dual tone, multi-frequency signals to be transmitted via the telephone line 30 to the telephone interface unit 20. The receiver 28 of the telephone interface unit 20 responds to the dual tone, multi-frequency signals and causes the RF transmitter 26 to transmit the appropriate coded RF activating signal which is radiated by antenna 27 throughout the area. The electronic tag having that coding responds to the activating signal and provides an audible signal and a visible indication for indicating the location of the eyeglasses. Of course the activation process can be initiated by a person at a remote location, allowing that person to anticipate a need, or to remind the called party to take a medicine, for example, by activating an electronic tag secured to a medicine bottle. Moreover, although the control unit 10 is shown in FIG. 1 to be a portable hand held unit, the control unit can be adapted to be carried on a chain, allowing the control unit 18 to be worn around the neck of the user.

Referring to FIG. 1B, an object locating system includes a master control unit 18, which can be used to activate a plurality of electronic tags 11-14. The master control unit has particular application in a nursing home or other type of assisted care facility, for enabling a person in charge to locate misplaced or lost items belonging to one or more residents of the facility.

The object locating system can include a control unit, such as in the systems shown in FIGS. 1 and 1B, or can include a telephone interface unit such as in the system shown in FIG. 1A, or can include a telephone interface unit in addition to a control unit. Moreover, the system can include more than one control unit and/or telephone interface units depending upon the particular application. For example, when used in a private dwelling, the object locating system can include both a control unit and a telephone interface unit. When used in a retirement home, a nursing home, or some other type of assisted care facility, the object locating system can include a plurality of control units.

Control Unit

Referring to FIGS. 2, 3 and 10, the control unit 10 includes a case 32, the selecting apparatus 15, a microprocessor 33, the RF signal transmitter 16, an indicator 34, and a power supply circuit 35. The control unit 10 is a self-contained, portable, hand-held, device. The case 32 encloses the components of the control unit 10. In one embodiment, the case 32 is made of a durable plastic.

The selecting apparatus 15 comprises a switch pad, which is mounted on an upper panel 36 of the case 32. The switch pad includes four switches 41-44. In one embodiment, the switches 41-44 are membrane-type switches providing tactile feedback in the form of raised portions on the surface of the switch. In one embodiment, the switch 41 includes a single raised portion 41a, and the switch 42 includes two raised portions 42a-42b. The switch 43 includes three raised portions 43a-43c, and the switch 44 includes four raised portions 44a-44d. Referring also to FIG. 4, each of the switches, such as switch 41, includes a dome area 45 ringed by an annular rib 46. Each of the four switches 41-44 is used to activate a different one of four carrier frequency signals. FIG. 7 shows a further embodiment of a switch pad 50 which includes membrane-type switches 51-54 providing tactile feedback in the form of raised ribs 55 on the surface of the switches.

Refer to FIGS. 2-5, panel 36 includes a region 38 adjacent to the switches having labels 39 secured thereto for associating each of the switches 41-44 with a different one of the objects to be located. The labels are contained within compartments 47 at one side of the switches. The compartments 47 are defined by stepped surface portions 48 as shown in FIG. 5. The stepped surface portions 48 are open at one end 49 to allow insertion of the labels 39, which can be of any suitable material. The outputs of the switch pad 15 are connected to a data input 37 of the microprocessor 33.

The microprocessor 33 is programmed to detect when one of the switches 41-44 is being operated, to determine which switch is being operated, and to cause the proper modulated carrier frequency signal to be transmitted. The microprocessor 33 can include suitable interface circuits interposed between the inputs/outputs of the microprocessor and switch pad 15, the RF transmitter 16 and the indicator 34, for example.

The microprocessor 33 responds to operation of one of the switches 41-44 and produces an output for controlling the RF signal transmitter 16. In one embodiment, the RF signal transmitter 16 produces four coded signals. Each coded signal represents a unique address for a different one of the four electronic tags 11-14. The coded signal is an RF carrier signal which is frequency modulated to be encoded with unique address data. The coded signal can also include suitable error detection information as is known in the art. The frequency modulated RF carrier signal is produced for a fixed time duration for each operation of one of the switches 41-44. In one embodiment, the frequency modulated RF carrier signal is active for ten seconds. The duration of the frequency modulated RF carrier signal can be implemented in controller software or hardware, allowing the frequency to be changed.

The control unit 10 can be battery powered by a standard 9 volt alkaline battery and the power supply circuit 35 can include a voltage regulating circuit for providing a regulated DC voltage for the electronic circuits of the control unit. In applications in which the control unit can be located at a fixed location, the control unit 10 can be powered by an external UL class 2 wall transformer (not shown) providing a 9 VDC output.

The indicator 34 can be mounted on the front panel 36. In one embodiment, the indicator 34 is a light emitting diode. The indicator 34 indicates when any of the four carrier signals are active by being triggered locally by operation of one of the switches 41-44. The light emitting diode 34 can be red or some other distinctive color. The indicator 34 is connected to an output of the microprocessor 33 which provides a driving signal for the indicator 34 in response to the operation of any one of the switches 41-44.

Referring to FIG. 6, the master control unit 18 includes a switch 58 which causes all four coded carrier signals to be generated at the same time. The master control unit 18 can be used to activate electronic tags associated with a plurality of objects. One application of the master control unit 18 is in a retirement home, a nursing home or other type of assisted care facility for locating items left behind by several residents of the facility. For example, when the residents return to their own rooms after a gathering in a common meeting room, it is generally the case that several of the residents will forget personal items, such as eyeglasses, keys, purses, for example. When the residents have left the meeting room, or even while they are in the process of leaving the meeting room, a person in charge can operate the switch 55, activating the electronic tags carried by items being left behind in the room. The items can then be collected and returned to their owners. The master control unit 18 includes a key ring attachment feature 18a formed in its case 18b which allows the master control unit to be attached to any item.

Electronic Tag

Referring to FIGS. 8, 9 and 11, the electronic tags 11-14 are identical and accordingly only one electronic tag 11 is described. The electronic tag 11 includes an RF signal receiver 60, a microprocessor 61, an alarm generator 62, an indicator 63, a power supply circuit 64 and a case 65 for containing the components of the electronic tag. In one embodiment, the case 65 is made of a durable plastic. The back 65b of the case 65 can be smooth so that the electronic tag can be attached, using double sided tape, to a TV remote control or other surface that cannot be attached to by a key ring, for example. In addition, the case 65 is adapted with a slide cover (not shown) to facilitate replacement of the battery. Each electronic tag can have an Arabic numeral, indicated at 69, from one to four to facilitate identification by an elderly user.

The RF signal receiver 60 receives the coded RF signals transmitted by the control unit 10 and converts the coded RF signals to digital signals, which are supplied to the microprocessor 61. The microprocessor 61 can include suitable interface circuits interposed between the inputs/outputs of the microprocessor and the RF receiver 16 the alarm generator 62 and the indicator 63, for example.

The microprocessor 61 is programmed to detect the address code and validate the address. The microprocessor 61 is further programmed to cause the alarm generator 62 to produce an audible output for a fixed time for each address signal received. In one embodiment, the alarm generating device is a piezo sound device or piezo-electric transducer. When activated, the piezo-electric transducer is pulsed twice during each of six two second intervals, as shown in FIG. 12, in line A. The pulse pattern includes a pulse of a first duration t₁, followed by a pause of a duration t₂, and then a second pulse of the duration t1. This pulse pattern (or duty cycle) is repeated for a total of six times, at a rate t₃. In one embodiment, the duration t₁ is 0.5 seconds, the duration t₂ is 1 second and the rate t₃ at which the pulses are provided is 5 seconds. However, other pulse durations and pulse rates can be used. The frequency of operation can be 1800-2200 Hz. The power level is greater than 85 dba at one foot. This frequency and power level enable an elderly person, with a limited hearing impairment to be able to hear and identify the location of the electronic tag. However, the alarm generator 62 can be any suitable transducer capable of producing an audible output signal when activated, and different frequency and power levels can be used.

In one embodiment, the indicator 63 is flashed for a duration t₄ occurring during the “off time” (t₂) between the sound pulse patterns produced by the transducer of the alarm generator as shown in FIG. 12, in line B. In one embodiment, the duration t₄ is 0.25 second. This occurs only for the third to the sixth pulse patterns (only pulse patterns 1, 3 and 4 are shown) to enhance battery life. However, the duration and frequency at which the indicator is energized can be other values depending upon battery power available for example.

The electronic tag 11 includes a key ring attachment feature 65a (i.e., an opening therethrough) which allows the electronic tag 11 to be attached to any item, such as keys, a purse zipper, a book-mark, that has a hole therein. In one embodiment, the electronic tag is removably attached to an object by hook and loop type fasteners, including a first portion 66 that is secured to the electronic tag and a second mating portion 67 that is secured to the object to be located. However, other types of attachment means, such as straps, double-sided tape, a key ring and the like, can be used. Although the electronic tag 11 is shown to be contained within a case 65, in some applications, the electronic tag can be in the form of a flat chip element (not shown) that is enclosed within a protective coating. The chip as well as is protective coating can be somewhat flexible allowing the electronic tag to be wrapped around a container, for example. This facilitate attaching the electronic tag to an object such as a pill bottle and the like.

Telephone Interface

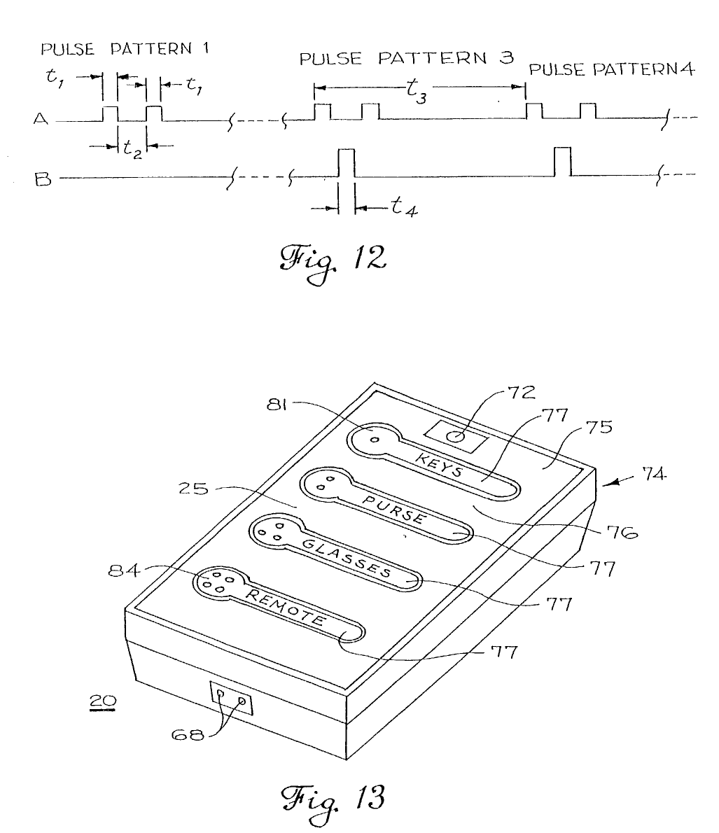

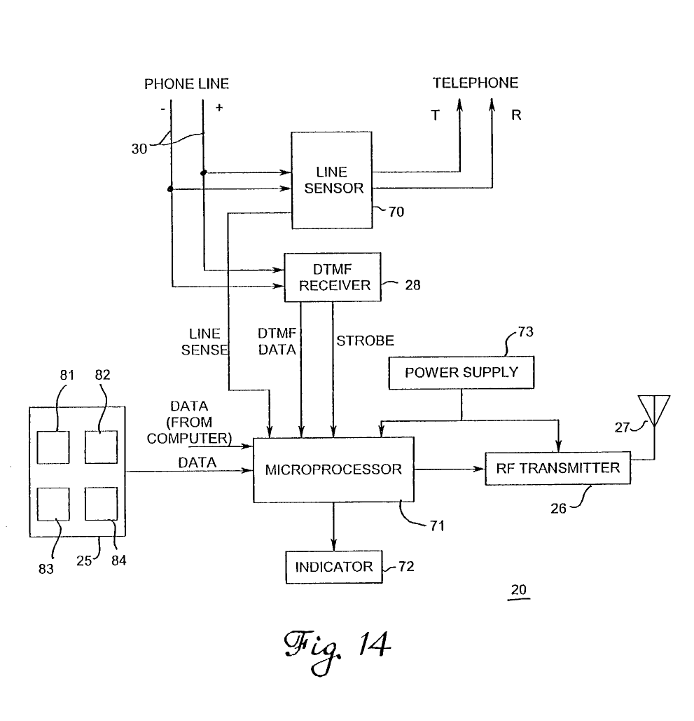

Referring to FIGS. 13 and 14, the telephone interface unit 20 includes the selecting apparatus 25, the RF transmitter 26, the multi-frequency receiver 28, a telephone line condition sensor 70, a microprocessor 71, an indicator 72 and a power supply circuit 73. In one embodiment, the components of the telephone interface unit 20 are housed within a common case 74 having an upper panel 75. However, the telephone interface unit 20 can be a modular unit with components such as the line condition sensor 70 and the multi-frequency receiver 28 being separate from the other components of the telephone interface unit, for example.

The line condition sensor 70 is connected in series with the telephone line 30 and the telephone 31 for detecting an off-hook condition for the telephone, or of an extension telephone 31a. The line condition sensor 70 provides an output LINE SENSE that becomes active for an off-hook condition for the telephone. In one embodiment, the line condition sensor 70 is a line sense relay. One line sense relay suitable for this application is the type M-949-01 Line Sense Relay, which is commercially available from Teltone Corporation, Bothell Wash., 98201.

The multi-frequency receiver 28 is connected across the telephone line 30 (in parallel with the telephone 31) for detecting multi-frequency signals being transmitted on the telephone line and for decoding the multi-frequency signals into digital signals. The multi-frequency receiver 28 has a data output connected to a data input of the microprocessor for supplying the digital signals to the microprocessor. The multi-frequency receiver 28 has a strobe output connected to a further input of the microprocessor 71 for providing an indication to the microprocessor 71 that multi-frequency signal data is available. In one embodiment, the multi-frequency receiver is a dual tone multi-frequency (DTMF) receiver. One dual tone multi-frequency receiver 28 suitable for this application is the type M-8870 DTMF Receiver, which is commercially available from Teltone Corporation, Bothell Wash., 98201.

In one embodiment, the telephone interface unit 20 includes two RJ-11 telephone jacks 68 to facilitate connection of the telephone interface unit 20 in circuit with the telephone line 30 and the telephone set 31. The telephone jacks 68 can be located on any of the side of the case 74, or even on the bottom of the case 74. The telephone interface unit 20 is connected in parallel with the telephone set 31 and monitors for DTMF signals during an active phone call. The telephone interface unit 20 does not load the telephone line. The telephone set 31, with which the telephone interface unit 20 is associated, must be actively in use during a telephone call for the decoding of the DTMF signals. However, the selecting apparatus 25 can be used to enter activation commands for either on-hook or off-hook conditions for the telephone 31. In one embodiment, the selecting apparatus 25 is a switch pad including four membrane-type switches 81-84.

The switch pad 25, which is similar to switch pad 15, can be mounted on panel 75 and includes four membrane-type switches 81-84 providing tactile feedback in the manner similar the switches 41-44 of switch pad 15 as described above with reference to FIGS. 2-5. Each of the four switches 81-84 is used to activate a different one of the four carrier frequency signals. The outputs of the switch pad 25 are connected to data inputs of the microprocessor 71. The panel 75 includes a region 76 adjacent to the switches having labels 77 secured thereto for associating each of the switches 81-84 with a different one of the objects to be located. The labels 77 are contained within compartments at one side of the switches 81-84 in the manner of compartments 47 as shown in FIG. 5. As described above with reference to FIG. 5, the compartments open at one end to allow insertion of the labels 77, which can be of any suitable material.

The microprocessor 71 is programmed to respond to the signal LINE SENSE becoming active to monitor the output of the receiver 28 for DTMF data. When DTMF data is present on input, the microprocessor processes the DTMF data to determine which digit has been transmitted, and causes the proper modulated carrier frequency to be transmitted. The microprocessor 71 is further programmed to detect when one of the switches 81-84 is being operated, to determine which switch is being operated, and to cause the proper modulated carrier frequency signal to be transmitted. The microprocessor 71 responds to operation of one of the switches 81-84 and produces an output for controlling the RF signal transmitter 26. In one embodiment, the RF signal transmitter 26 produces four coded signals. Each coded signal represents a unique address for a different one of the four electronic tags 11-14. The microprocessor 71 can include suitable interface circuits interposed between the inputs/outputs of the microprocessor and the receiver 28, switch pad 25, RF transmitter 26, for example.

The microprocessor 71 is further programmed to produce a randomly generated identification code in the manner known in the art. An identification code is generated once upon first power up or simultaneous selection of a pair of keys of the telephone 30, such as keys 1 and 2, for a predetermined duration of time, such as five seconds. An electronic tag, such as tag 11, upon power up (when the battery is placed in the unit) will enter a learn mode. Any activation of the telephone interface unit 20, at this point, will “brand” the tag(s) to that specific telephone interface unit. The “branding” of the electronic tags to specific telephone interface units ensures that one telephone interface unit will not activate electronic tags associated with another telephone interface unit while co-located.

The RF signal transmitter 26 is connected to an output of the microprocessor 71. The RF signal transmitter 26 can be the similar in function and operation as the transmitter 16 for the control unit 10. The telephone interface unit 20 is capable of signaling on each of the four system radio frequencies thereby acting as a base unit for the object locating system. The RF signal transmitter 26 can include an antenna 27 for radiating the coded RF signals.

The telephone interface unit 20 is a local and remote control device to activate radio carrier-based tags. The telephone interface unit 20 can be activated either locally through the use of the switches 81-84 of the switch pad 25 or remotely through the monitoring of conventional dual tone multi-frequency signals on a standard telephone line of a public switched telephone network. In one embodiment, channel 1 is digit 1 (frequency pair 697 Hz and 1209 Hz), channel 2 is digit 2 (frequency pair 697 Hz and 1336 Hz), channel 3 is digit 3 (frequency pair 697 Hz and 1477 Hz) and channel 4 is digit 4 (frequency pair 770 Hz and 1209 Hz). In addition, a further DTMF signal, including frequency pair 941 Hz and 1209 Hz corresponding to the * key, is used. While reference is made to specific pushbutton keys for describing the operation of the object locating system, other ones of the available frequency pairs can be used to effect activation of the electronic tags. The radio frequency carrier signal is active for ten seconds for each validly-recognized DTMF tone sequence or each activation of a switch on the switch panel. In one embodiment, a preselected sequence of DTMF tones, such as * * 1 is used to cause the activation of electronic tag 11. Tone sequence **2 is used to cause the activation of electronic tag 12. Tone sequence * * 3 is used to cause the activation of electronic tag 13. Tone sequence * * 4 is used to cause the activation of electronic tag 14.

The indicator 72 can be mounted on the panel 75. The indicator 72 is connected to an output of the microprocessor 71. The indicator 72 provides a visual indication when any of the four carrier signals is active, whether triggered locally via the front panel switches 81-84 or by telephone DTMF signals transmitted on the telephone line and detected by the receiver 28. In one embodiment, the indicator 72 is a red light emitting diode. However, light emitting diodes, or other types of visual indicators, which produce light of color other than red can be used.

In one embodiment, the telephone interface unit 20 is battery powered by a standard 9 volt alkaline battery and the power supply circuit 73 can include a suitable voltage regulating circuit for providing 5 VDC, for example, for the electronic circuits of the telephone interface unit. Alternatively, the telephone interface unit 20 can be powered by an external UL class 2 wall transformer (not shown) providing a 9 VDC output.

Operation

Referring to FIGS. 13 and 14, by way of illustration of the operation of the remote system, it is assumed that a person is unable to locate an item, such as a pair of eyeglasses, and that the person needs assistance in locating the eyeglasses. The person telephones a relative, neighbor or friend, for example, and lets that called party know that the caller is having difficulty locating the eyeglasses. When the caller initiates the telephone call, the line relay operates, causing the output LINE SENSE to become active for indicating to the microprocessor 71 that a telephone call is in progress and that DTMF data may be provided.

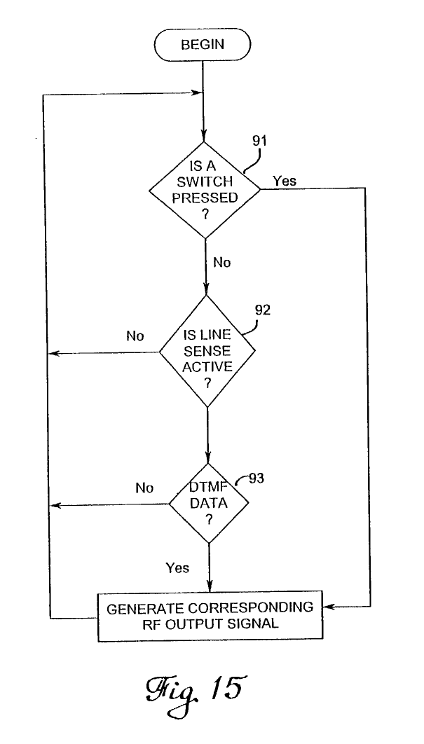

The microprocessor 71 continuously monitors the input from the key pad 25 to determine whether one of the switches 81-84 has been operated, and monitors the input from the line sense relay 70 to determine whether the output LINE SENSE is active. Referring also FIG. 15, if at decision block 91, the microprocessor 71 determines that none of the switches 81-84 of switch pad 25 is depressed, the process continues to decision block 92 which determines whether the output LINE SENSE is active. If not, the program loops back to block 91 to again check the status of the switch pad 25.

When decision block 92 determines that the output LINE SENSE is active, the program steps to decision block 93 and the microprocessor 71 begins to monitor the input from the DTMF receiver on a periodic basis. If a dual tone, multi-frequency signal is not being detected by the DTMF receiver 28, the program loops back to block 91 and again determines whether any one of the key pad switches 81-84 is depressed. Digressing, the microprocessor 71 continues to monitor the output of the key pad 25, block 91, so that the DTMF receiver 28 does not override the key pad 25.

Returning to the example, assuming the called party has answered the telephone and has learned that the calling party needs assistance in locating their eyeglasses, the called party then depresses the “*” pushbutton twice and then depresses the “digit 3” pushbutton on their telephone. In the exemplary embodiment, transmission of the DTMF tone sequence “* * 3”, including the DTMF tones corresponding to the digit number “3”, will cause the telephone interface unit 20 to transmit the coded frequency signal that activates electronic tag 13 carried by the eyeglasses. The DTMF tone sequence is transmitted to the DTMF receiver 28. The DTMF receiver 28 detects the DTMF tone sequence and provides an appropriate input for the microprocessor 71. As the program continues, the DTMF data provided by the DTMF receiver is detected at block 93 and the program continues to block 94. At block 94, microprocessor 71 processes the DTMF data provided by the DTMF receiver 28 and causes the corresponding RF output signal to be transmitted. In addition, the microprocessor causes the indicator 72 to be flashed. In the present example, the microprocessor 71 determines that the coded signal for object #3, i.e., eyeglasses, is to be transmitted. The microprocessor 71 provides a suitable output to the RF transmitter to cause the coded frequency signal to be produced and radiated throughout the area. The electronic tag 11 that has the coding responds to the coded RF signal and produces an audible indication for alerting the calling party of the location of the eyeglasses.

If the calling party fails to find the eyeglasses in response to the transmission of the DTMF signal. The activation process can be repeated until the lost or misplaced eyeglasses have been located. It is pointed out that the called party also can tell the person seeking the eyeglasses to depress switch 81 which will cause the appropriate coded signal to be transmitted. Thus, if at block 91 it is determined that one of the outputs of the switch pad 25 is active, the microprocessor can determine which one of the four switches 81-84 has been operated and can then control the RF signal transmitter to produce the appropriate coded frequency signal.

When the eyeglasses have been located, and the telephone conversation is completed, the calling or called party hangs up, which causes the line relay 70 to deactivate the LINE SENSE signal and the object locating system is prepared for the next call.

Monitoring System

The object locating system can be used in a retirement home, a nursing home, or other assisted care facility, which has a central monitoring area on each floor, or otherwise a person designated to assist residents when necessary. In such application, each resident can carry or wear their own control unit, such as control unit 10. The control unit can be activated to produce a signal that is received by a central monitoring station, such as a nurses station on a floor of a nursing home, or by a master control attended by a designated person.

In this system, a resident in his/her room can operate the switch 43 labeled eyeglasses causing a coded RF signal to be transmitted to the central monitoring station. The coded RF signal is received at the central monitoring station, and a person in charge can operate a control unit, such as a control similar to telephone interface unit 20 to transmit RF coded signals to various locations or areas within the nursing home in an attempt to activate an electronic tag associated with the lost or misplaced object allowing the object to be located. The locations to which the RF signal is transmitted can include the resident's room and public rooms on the resident's floor, as well as other locations within the nursing home.

In one preferred embodiment, a person at a central monitoring station can use a computer at that location for causing a control unit, such as a telephone interface unit 20, to transmit RF coded signals to various locations or areas within the nursing home in an attempt to activate an electronic tag associated with the lost or misplaced object allowing the object to be located. In this embodiment, an output of the computer can be coupled to the microprocessor 71 (FIG. 14) of the telephone interface unit 20. The computer is programmed by an object locator program to respond to inputs provided to the computer, such as via the keyboard, to provide digital data signals, similar to those that are produced by the DTMF receiver 28, to the microprocessor 71 to cause the appropriate coded RF signal to be transmitted throughout the facility.

By way of example, it is assumed that one of the residents has misplaced their eyeglasses. That person can alert an attendant at the central monitoring station that assistance is needed in locating the misplaced item. The attendant accesses the object locator program and types in or otherwise enters into the computer the name of the person for whom an item is being sought, and then enters the name “glasses” of the item being sought. The attendant then clicks on a “FIND” icon that is being displayed on the screen of a monitor of the computer, which causes the computer to process the information inputted and to generate the appropriate command for the telephone interface unit 20. The microprocessor 71 responds in the manner similar that for inputs supplied by the switch pad 25 or the receiver 28 and causes transmission of the activating signal for the electronic tag that is carried by the glasses being sought. The activating signal will cause the electronic tag associated with the glasses to produce its audible alarm and its visual indication, so that the glasses can be found and returned to their owner.

Luggage Tag

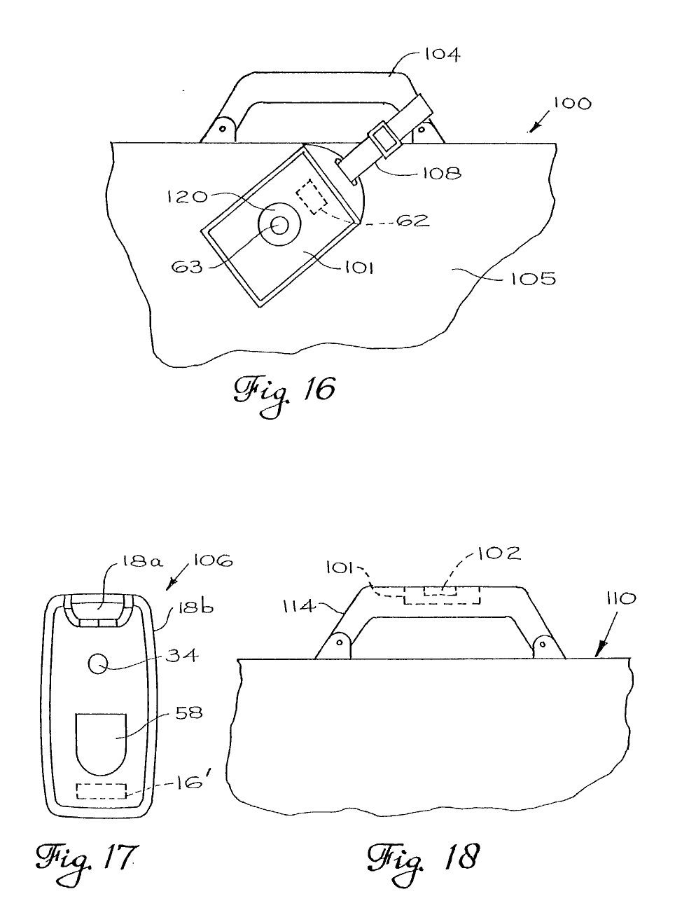

Referring to FIGS. 16 and 17, further in accordance with the invention, there is provided a system for identifying as well as locating objects. In particular, the object identifying and locating system can be used as an electronic luggage identifier and locator for identifying baggage, such as luggage, sporting equipment, packages, and the like which have been checked during travel, such as during a flight on an airplane. In this embodiment, an electronic tag or luggage locator tag 101 (FIG. 16) can be activated by a control unit 106 (FIG. 17) to uniquely identify packages or baggage, such as a piece of luggage 100, where, for instance, the general location of the luggage is known, but where many identical or similar pieces of luggage are being delivered to a relatively large number of people in a common area. An example of this is the baggage return in an airport terminal where the baggage is dispensed from a baggage carousel in an airport and the baggage is being retrieved from the carousel by a large number of people, typically one hundred or more. The luggage locator tag 101 can be similar to electronic tag 11 shown in FIGS. 24 and 11. Accordingly, elements of the luggage locator tag 101 have been given the same reference numerals as like or similar components of electronic tag 11. The control unit 106 can be similar to master control unit 18 shown in FIG. 6, which includes components of control unit 10 (FIG. 10) in which the switch pad 15 of control unit 10 is replaced by a single switch 58. Accordingly, elements of control unit 106 have been given the same reference numerals like or similar elements of the control unit 18, and the RF signal transmitter of control unit 106 has been given the reference numeral 16′. In addition, the RF transmitter 16′ of control unit 106 provides only one coded modulated RF carrier signal.

In the object locating system described above with reference to FIGS. 1 and 1A, for example, the control unit 10 (or telephone interface unit 20) is used to activate one of four electronic tags 11-14, for example, of the system. The object identifying and locating system employing the luggage locator tag 101 and the control unit 106 can be considered as a subset of the object locating system wherein a control unit 106 activates a single tag 101, or simultaneously activates a plurality of tags 101 which have the same frequency coding, for allowing a person to identify one or more pieces of luggage as the luggage is being dispensed from a baggage carousel in an airport, for example. The control unit 106 includes a key ring attachment feature 18a, which allows the control unit to be attached to any item having a hole, and particularly, an item such as a key ring. The control unit 106 includes a pushbutton or switch 58 for activating the RF signal transmitter 16′ of the control unit 106. The control unit 106 includes an indicator 34 for indicating when a coded signal is being transmitted by the RF transmitter 16′ of the control unit 106.

In one embodiment, the luggage locator tag 101 includes a piezo electric transducer 62, which produces an audible sound when energized, and an indicator 63 which is lit when energized. The transducer 62 and the indicator 63 can have the same duty cycle as described above with reference to FIG. 12, for like numbered components of the electronic tag 11. The luggage locator tag 101 can be removably secured to the luggage 100. For example, the luggage locator tag 101 can be attached to a handle 104 of the luggage by a strap 108, or can be attached to the outer surface 105 of the luggage in a suitable manner. Moreover, the luggage locator tag 101 can be in the form of a fob or a key ring that can be removably attached to the luggage. Alternatively, the luggage locator tag 101 can be built into the handle 111 of a piece of luggage 110 as shown in FIG. 18.

Referring to FIG. 19, in another embodiment, one or more luggage locator tags 116 are incorporated into the fabric or surface 117 of the luggage 115 at locations on each side surface of the luggage. The luggage locator tags 116 both light up and produce an audible signal when activated. Referring to FIG. 20, in a further embodiment, a luggage locator tag 118 is in the form of a strip that can be illuminated. One known type of strip lights includes a string of lights 119 mounted within a sheath 119a of transparent plastic tubing. The lights can be energized in sequence, producing a strobe-like effect. The strip of lights preferably can be built structurally into and incorporated into the fabric and/or a surface structure of the luggage, and can extend 3600 around the luggage. The foregoing arrangements are more permanent and the luggage locator tags can be built into the luggage by the manufacturer of the luggage.

Referring to FIG. 21, to enhance the visibility of the light indication produced by the luggage locator tag 101, the luggage locator tag 101 can include a dome or lens 120 for focusing the light to make it more visible. The indicator 63 is located behind the lens, and illuminates the lens when the indicator is activated. The presence of the lens results in the light being “raised” out of the plane 122 of the luggage tag (represented by the upper surface of the luggage tag), making the light indication more readily seen. Moreover, the lens can be colored, with the color being selected to make the luggage to which the luggage locator tag 101 is attached be more distinctive.

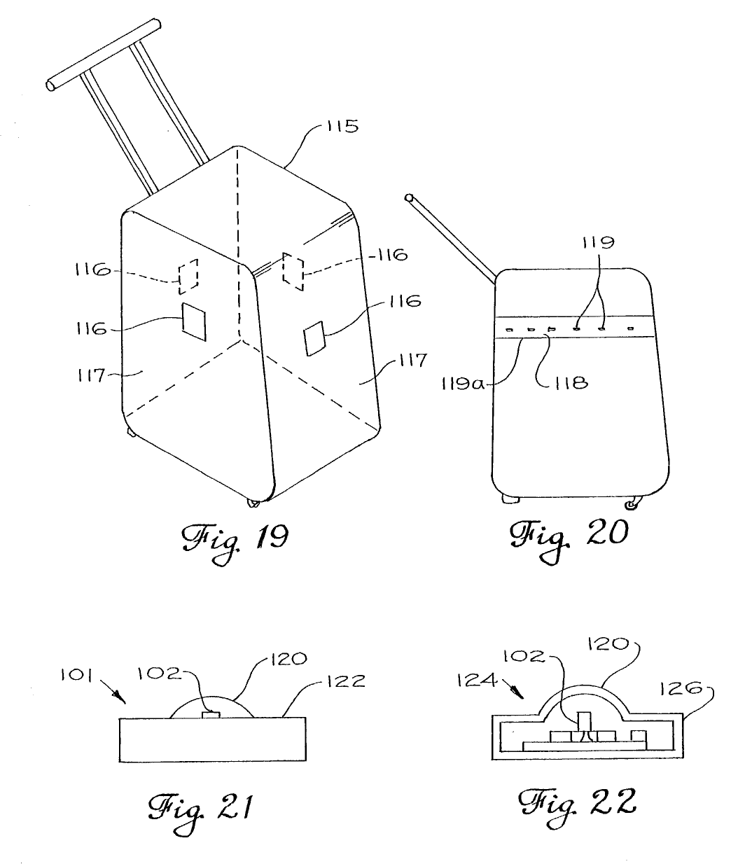

Also, because baggage retrieval areas typically are noisy areas, the luggage locator tag can be configured to not produce an audible signal, so that only a light indication is provided. Different colors of light can be provided for different object identifying systems by selection of the type of indicator used. Moreover, as shown in FIG. 22, a luggage locator tag 124 can have a housing 126 of a transparent material increasing the viewability of the indicator 63.

Preferably, the luggage locator tag 101 can provide additional unique physical identification. For example, the housing of the luggage locator tag 101 can itself be of a unique color or pattern. Alternatively, the luggage locator tag 101 can be attached to the luggage by a strap or a band 108 (FIG. 16) which is of a distinctive pattern or configuration that is known to the owner for making the luggage locator tag. In either case, the luggage locator becomes more readily recognizable by the user of the luggage.

Vehicle Key Locator

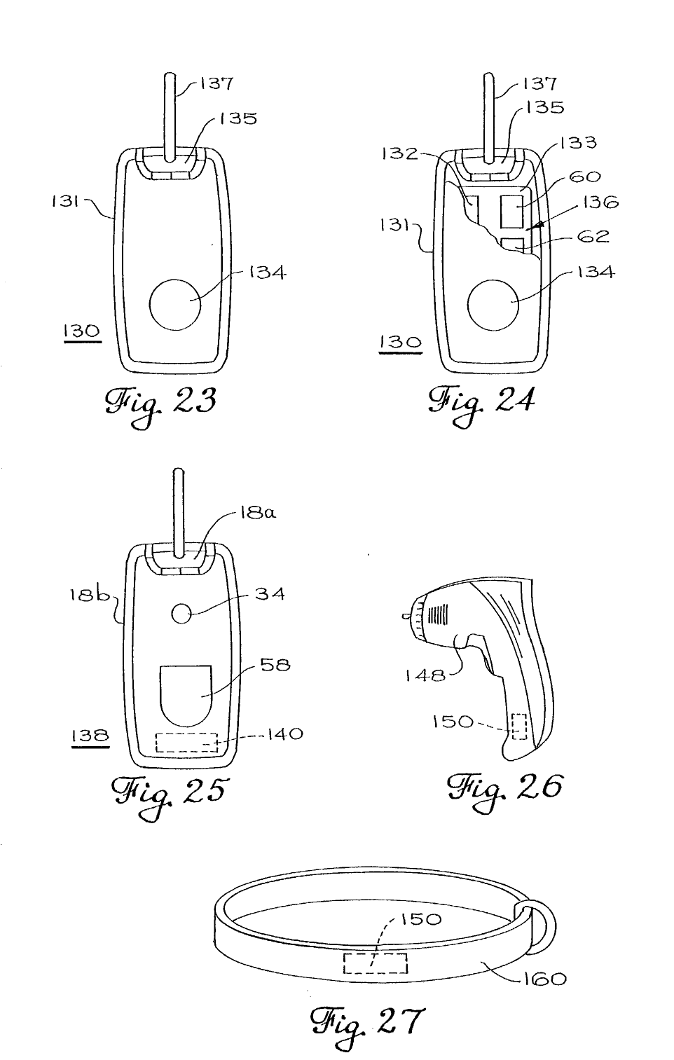

Referring to FIGS. 23-25, further in accordance with the invention, there is provided a system for locating a set of keys for a vehicle. By way of example, the vehicle keys can be attached to a fob 130, which provides remote keyless entry (RKE) for the vehicle in the manner known in the art. The fob 130 includes a housing 131 containing an electronic circuit 132, shown in FIG. 24, including an RF transmitter. The RF transmitter is activated in response to manual operation of a pushbutton 134 mounted on the housing 131. When activated, the RF transmitter transmits a coded RF signal to the vehicle. An RF receiver (not shown) in the vehicle responds to the coded RF signal and unlocks the doors of the vehicle only when a proper coded signal is received. The electronic circuit 132 can be mounted on a printed circuit board 133. The electronic circuit 132 obtains electrical power from a battery (not shown) located within the housing. The housing 131 can include a key ring feature 135 for receiving a key ring 137 for holding one or more keys (not shown), including an ignition key for the vehicle.

The vehicle key locating system includes an electronic locator circuit, indicated generally by reference numeral 136 in FIG. 24, can be activated by a control unit 138 (FIG. 25) to locate the keys. The components of the electronic locator circuit 136 can be similar to those of the electronic tag 11 shown in FIGS. 8 and 11. Accordingly, components of the locator circuit 136 have been given the same reference numerals as like or similar components of electronic tag 11.

In one preferred embodiment, the components of the electronic locator circuit 136 are integrated into the fob 130. The components of the electronic locator circuit 136 which are integrated into the fob 130 include an RF receiver 60, a microprocessor 61 (FIG. 11), and a piezo electric transducer 62 which produces an audible sound when energized. The components of the electronic locator circuit 136, including RF receiver 60, a microprocessor 61 and piezo electric transducer 62, can be discrete components mounted on the printed circuit board 133. Moreover, at least some of the electronic components of the electronic locator circuit 136, such as the RF receiver 60 and the microprocessor 61 can be incorporated into the RKE circuits 132 of the fob. The electronic locator circuit 136 can include an indicator, such as indicator 63 for locator tag 11 (FIG. 8), which is lit when energized. Electrical power for the electronic locator circuit 136 can be provided by the battery for RKE circuits of the fob 130. The transducer 62 and the indicator 63 (when provided) can have the same duty cycle provided under microprocessor control as described above with reference to FIG. 12, for like numbered components of the electronic tag 11. Alternatively, the components of the locator circuit 136 can be enclosed within a housing in the manner of locator tag 11 (FIG. 8) which can be adapted to be attached to a surface of the fob 130 or placed on a key ring attached to the fob.

Referring to FIG. 25, the control unit 138 is similar to the control unit 106 shown in FIG. 17, which, in turn, includes components of control unit 10 shown in FIG. 10. In control unit 106, the switch pad 15 of control unit 10 is replaced by a single switch 58. Accordingly, elements of control unit 138 have been given the same reference numerals like or similar elements of the control unit 106, and the RF signal transmitter of control unit 138 has been given the reference numeral 140. In one embodiment, the RF signal transmitter 140 of control unit 138 provides only one coded modulated RF carrier signal. In the object locating system described above with reference to FIGS. 1 and 1A, for example, the control unit 10 (or telephone interface unit 20) is used to activate one of four electronic tags 11-14, for example, of the system. The object locating system employing the electronic locator circuit 136 and the control unit 138 can be considered as a subset of the object locating system wherein a control unit 138 activates a single electronic locator circuit 136 which corresponds to a single locator tag.

The control unit 138 includes a pushbutton or switch 58 for activating the RF signal transmitter 140 of the control unit 138. The control unit 138 can include an indicator 34 for indicating when a coded signal is being transmitted by the RF transmitter 140 of the control unit 138. When not in use, the control unit 138 can be stored in any convenient location, such as on a hook or in a drawer in a kitchen or some other room of a house, for example.

In the event the car keys are misplaced, the user takes the control unit 138 from its storage place and depresses the pushbutton 58. The control unit 138 responsively transmits an RF signal which activates the locator circuit 136, causing the transducer 62 to produce an audible alarm to indicate to the user the location of the vehicle key set. Also, when provided, the indicator is caused to light, producing a visible indication to the user.

Portable Tool Locator

Referring to FIG. 26, further in accordance with the invention, the object locating system can be used for locating a portable hand tool 148, such as a hand drill illustrated in FIG. 26, a portable electric saw, and the like or any other hand tool, such hammers, saws, etc. In this embodiment, a locator tag 150 (FIG. 16) can be activated by a control unit, such as control unit 106 (FIG. 17), to locate the hand tool 148. In this embodiment, the locator tag 150 can be similar to electronic tag 11 shown in FIGS. 8 and 11. Referring also to FIG. 11, the locator tag 150 includes components of electronic tag 11 including an RF receiver 60, a microprocessor 61, a piezo electric transducer 62 and an indicator 63. The locator tag 150 can include a power supply 64, such as a battery. The transducer 62 and the indicator 63 can have the same duty cycle, produced under microprocessor control, as described above with reference to FIG. 12, for like numbered components of the electronic tag 11.

In one embodiment, the locator tag 150 is integrated into the hand tool 148 and can be mounted on an interior surface of the housing 152 of the hand tool when the tool housing is of a material capable of passing RF radiation or at any other suitable location within the housing 152 of the hand tool. Alternatively, the locator tag can be attached to an exterior surface of the tool, or can be mounted on a power cord of the hand tool when the hand tool includes a power cord. The components of the locator tag 150 can be enclosed within a housing or can be produced on a substrate suitable for mounting within the hand tool and adapted to be connected to a battery also mounted within the hand tool.

In one embodiment, the control unit 106 (FIG. 17) activates a single locator tag 150. In such an embodiment, the control unit 106 includes a single pushbutton or switch 58 for activating the RF signal transmitter 16′ of the control unit 106. The RF signal transmitter produces only one coded modulated RF carrier signal. The control unit 106 can include an indicator 34 for indicating when a coded signal is being transmitted by the control unit. However, the control unit can correspond to the control unit 18, shown in FIG. 6, and activate four locator tags for locating four different hand tools at the same time. In addition, a single RF frequency can be used to locate a plurality of hand tools when the locator tags for all of the hand tools operate at the same RF frequency.

Moreover, the object locating system can be used to locate animate objects such as a pet or some other animal. Thus, in another embodiment, a locator tag, such as locator tag 150, can be incorporated into a pet collar 160, as shown in FIG. 27, to enable a pet, such as a dog, a cat, etc. to be located using the object locating system.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

What is claimed is:

1. A system for locating a plurality of objects, the system comprising:
a control unit including a control, an RF transmitter for producing a plurality of uniquely coded signals, and a microprocessor interposed between the control and the RF transmitter for transmitting a plurality of coded RF activating signals, the control including a selecting apparatus for selecting the coded RF activating signals, the selecting apparatus including at least one switch for selecting a plurality of coded RF activating signals; and
a plurality of remote units, each of the remote units including an RF receiver for receiving the activating signals transmitted by the RF transmitter and for producing a control output, and an audible signal producing device, and a microprocessor interposed between the RF receiver and the audible signal producing device, each of the remote units being adapted to be coupled to one of the objects to be located, and each remote unit being activated in response to a different one of the coded activating signals to produce an output.

2. The system according to claim 1, wherein the selecting apparatus further comprises a plurality of switches for selecting one of four frequencies to be transmitted.

3. The system according to claim 1, wherein the control unit is a self-contained, battery-powered portable unit.

4. The system according to claim 1, wherein the control unit includes an indicator for indicating when any of the activating signals is being transmitted.

5. The system according to claim 4, wherein the apparatus includes a further switch for causing all four frequencies to be transmitted.

6. The system according to claim 1, wherein the remote unit includes an indicator for indicating when an activating signal is being received, and a signal generating device for providing and audible indication that an activating signal is being received.

7. A system for locating a plurality of objects, said system comprising:
a control unit adapted for coupling to a communication link;
a signal detector for detecting signals transmitted over the communication link and providing a selection signal;
an RF transmitter for transmitting a plurality of coded RF activating signals, the RF transmitter being coupled to the signal detector and being responsive to the selection signal for transmitting one of the coded RF activating signals; and
at least one remote unit adapted to be coupled to one of the objects to be located, the remote unit including an RF receiver for receiving the RF activating signals and providing a control signal, and an indication producing device responsive to the control signal for producing at least an audible indication.

8. The system according to claim 7, and further including a selecting apparatus coupled to the RF transmitter for selectively activating the RF transmitter to produce the coded signals.

9. The system according to claim 8, wherein the selecting apparatus includes a plurality of manually operable switches.

10. The system according to claim 7, wherein the RF receiver detects dual tone multi-frequency signals transmitted on the communication link.

11. The system according to claim 7, and including an indicator for indicating that a coded RF activating signal is being transmitted by the RF transmitter.

12. The system according to claim 11, wherein the communication link is a telephone line, and wherein the multi-frequency receiver responds to dual tone multi-frequency signals transmitted initiated by a telephone coupled to the telephone line to cause the RF signal transmitter to transmit a selected one of the coded RF activating signals.

13. The system according to claim 7 wherein the communication link is a telephone line, and wherein the interface unit includes a line status detector for indicating the status of the telephone line.

14. A system for identifying at least one object, said system comprising:
a control unit including an RF transmitter for transmitting a coded RF activating signal, a microprocessor, and a switch coupled to the transmitter for selecting a coded signal to be transmitted;
at least one identification tag adapted to be carried by the object to be identified, said one identification tag including an RF receiver for receiving the coded RF activating signal and providing a control output, an indicator for producing visible light when energized, and a microprocessor interposed between the RF receiver and the indicator, the microprocessor being programmed to respond to the control output to energize the indicator;
the indicator providing a unique appearance for identifying the object to be identified, wherein the identification tag is a generally planar member and includes a dome-shaped element overlying the indicator, whereby the light is raised out of the plane of the identification tag.

15. The system according to claim 14, wherein the identification tag includes a lens overlying the indicator, the dome being illuminated presenting a distinctive color.

16. A system for identifying at least one piece of luggage, said system comprising:
a control unit including an RF transmitter for transmitting a coded RF activating signal, a microprocessor, and a switch coupled to the transmitter for selecting a coded signal to be transmitted;
at least one identification tag carried by the piece of luggage to be identified, the identification tag including an RF receiver for receiving the coded RF activating signal transmitted by the RF transmitter and producing an output control signal, and an indication producing device responsive to the output control signal for providing an audible and/or visual indication.

17. The system according to claim 16, wherein the indication producing device presents a unique visual appearance for identifying the piece of luggage.

18. The system according to claim 16, wherein the identification tag is secured to the piece of luggage and the securing means is of a distinctive color.

19. The system according to claim 16, wherein the securing means comprises a strap or band of a distinctive color, for uniquely identifying the piece of luggage.

20 The system according to claim 16, wherein the identification tag is built into the piece of luggage and the securing means is of a distinctive color.

21. The system according to claim 16, wherein the identification tag includes a lens overlying the indicator, the dome being illuminated presenting a distinctive color.

22. The system according to claim 16, wherein the identification tag is a generally planar member and wherein the lens is a dome-shaped element, whereby the light is raised out of the plane of the identification tag.

23. A method for locating at least one object, said method comprising:
securing an RF receiver to the object to be located;
providing an RF transmitter for transmitting a plurality of RF activating signals to the RF receiver;
locating the RF transmitter in the proximity of the RF receiver;
coupling the RF transmitter to a communication link; and
transmitting a frequency signal over a communication link to the RF transmitter for causing the RF transmitter to transmit one of the coded RF activating signals.

24. The method according to claim 23, wherein the frequency signal comprises a dual tone, multi-frequency signals and including detecting the dual tone, multi-frequency signal and producing a control output for activating the RF transmitter.

25. The method according to claim 23, wherein the frequency signal is a dual tone, multi-frequency signal generated by a telephone coupled to the communication link at a location remote from the location of the RF transmitter.
